(19) United States
(12) Patent Application Publication
(10) Pub. No.: US 2017/0075312 A1
(43) Pub. Date: Mar. 16, 2017

(54) Baby bottle serving pair with freshness indicator

(71) Applicants: Aaron Hammond, Smyrna, GA (US); Shedra Hammond, Smyrna, GA (US)

(72) Inventors: Aaron Hammond, Smyrna, GA (US); Shedra Hammond, Smyrna, GA (US)

(21) Appl. No.: 15/215,437

(22) Filed: Jul. 20, 2016

Related U.S. Application Data
(60) Provisional application No. 62/217,056, filed on Sep. 11, 2015.

(51) Int. Cl. G04F 13/02; A61J 11/00; G01K 11/12; A61J 9/02

(52) U.S. Cl. CPC G04F 13/02; A61J 9/02; A61J 11/008; G01K 11/12; A61J 2205/20

(57) ABSTRACT

A baby bottle serving pair provides two 4-ounce baby bottles and a freshness indicator. The serving pair is comprised of two 4-ounce baby bottles, an upper bottle and a lower bottle, whose bottom surfaces may be secured to each other with screw threads. Each nipple provides a heat sensitive ring which begins to change color when exposed to the warmth of the baby's lips, and may be used as a timer to determine the freshness of the baby formula or breast milk in the bottle.

### CROSS-REFERENCE TO RELATED APPLICATIONS

This Application claims the benefit of U.S. Provisional Application No. 62/217,056, filed Sep. 11, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to infant and child care accessories, and in particular to a baby bottle serving pair with freshness indicator. Young parents are frequently challenged, and sometimes overwhelmed, by the sheer quantity of infant care items which are typically acquired. The complexity of this inventory and the increased mobility of modern lifestyles combine to make life difficult, as these items generally need to fit into a diaper bag and may be easily lost. Any infant care item which serves multiple purposes, stores and carries easily, can be easily secured to other items to prevent loss, and is simple to use would be well-received. A baby bottle serving pair with freshness indicator, providing two 4-ounce bottles which may be secured to each other, and heat-sensitive rings below the nipples which change color to indicate freshness level of the contents, would resolve this problem.

### SUMMARY OF THE INVENTION

Accordingly, the invention is directed to a baby bottle serving pair with freshness indicator. The serving pair is comprised of two 4-ounce baby bottles, an upper bottle and a lower bottle, whose bottom surfaces may be secured to each other with screw threads. Each nipple provides a heat sensitive ring which begins to change color when exposed to the warmth of the baby's lips, and may be used as a timer to determine the freshness of the baby formula or breast milk in the bottle.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top perspective view of the upper bottle component of the first exemplary embodiment, displaying the upper bottle 11, the nipple 15, and the ring 16.

FIG. 2 is a front view of the first exemplary embodiment with the bottles separated, displaying the bottles 10, the upper bottle 11, the lower bottle 12, the female threads 13, and the male threads 14.

FIG. 3 is a front view of the first exemplary embodiment with the bottles affixed, displaying the bottles 10, the upper bottle 11, the lower bottle 12, and the caps 17.

FIG. 4 is a flow chart of the method of use of the first exemplary embodiment.

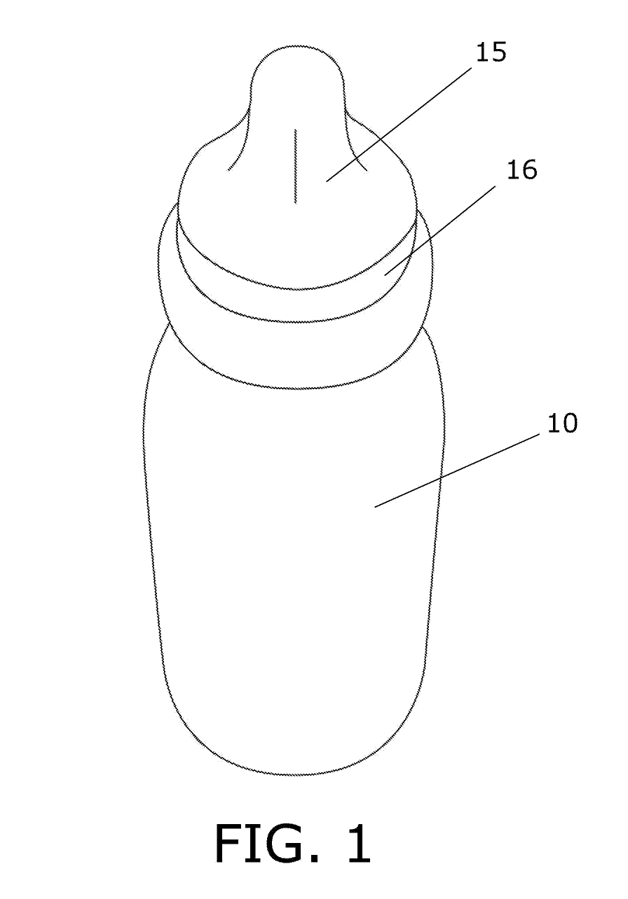

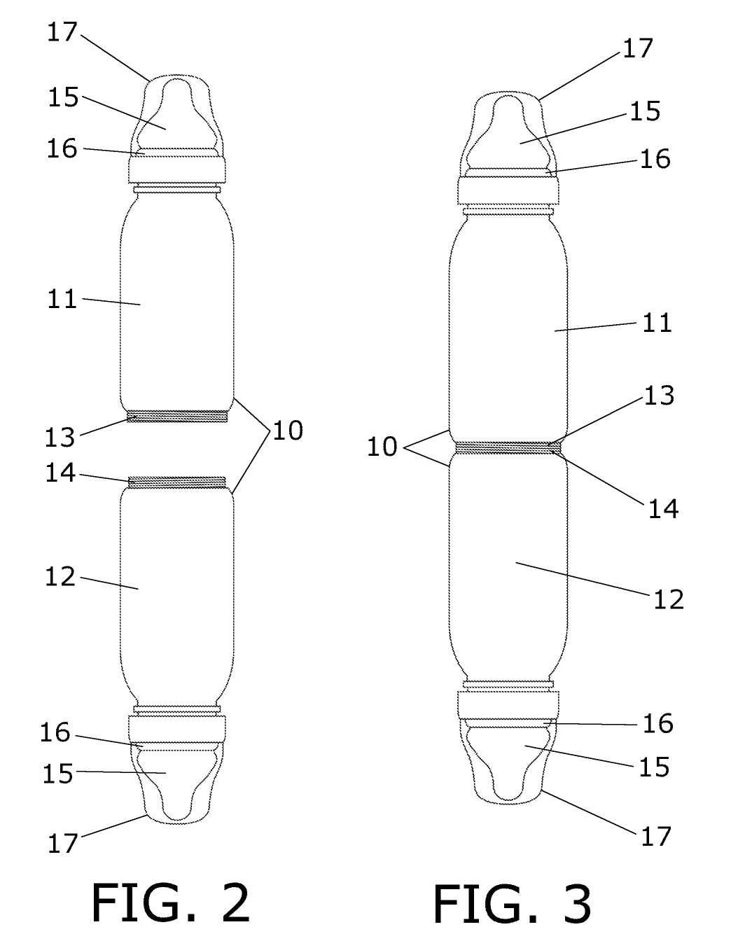

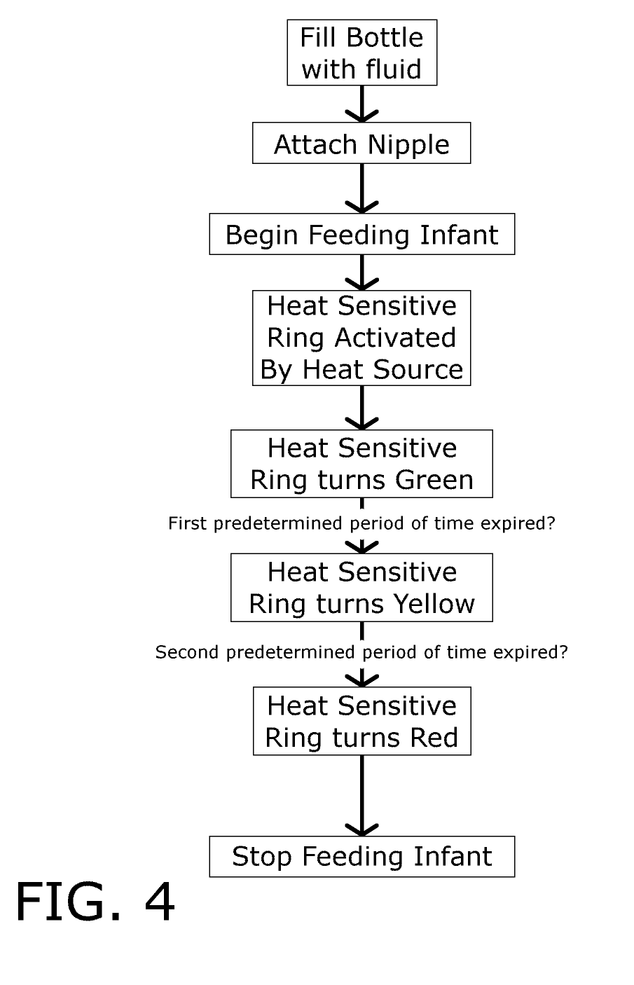

### DETAILED DESCRIPTION OF THE INVENTION

Referring now to the invention in more detail, the invention is directed to a baby bottle serving pair with freshness indicator 10.

The first exemplary embodiment is comprised of two 4-ounce baby bottles, an upper bottle 11 and a lower bottle 12, which are conventional in structure and function with the following modifications. The bottom surfaces (11A and 12A respectively) of the bottles (11 and 12) may be secured to each other with screw threads (13 and 14). Preferably, female threads 13 are provided on the bottom surface 11A of the upper bottle 11, and male threads 14 are provided on the bottom surface 12A of the lower bottle 12. Affixing the bottles (11 and 12) together saves space in a diaper bag or other storage space, and makes the bottles (11 and 12) more difficult to lose.

Each baby bottle (11 and 12) provides a nipple 15. Each nipple 15 provides a heat sensitive ring 16 which begins to change color when exposed to heat. Upon being exposed to a heat source, such as the infant's lips or a warmed baby formula, the ring 16 is activated. When activated, the ring 16 changes color to green. An alternate embodiment, in which the ring 16 begins to change color upon being exposed to both a heat source and airflow through the nipple 15, is contemplated. The heat sensitive ring 16 changes colors after predetermined periods of time. The first predetermined period of time is preferably 30 minutes, at which point, the color of the heat sensitive ring 16, changes to yellow. A final predetermined period of time is preferably 60 minutes, at which point, the color of the heat sensitive ring 16, changes to red. In an alternate embodiment, the heat sensitive ring 16 glows in the dark. The color the heat sensitive ring glows remains the same (i.e. green when first activated, yellow after a first predetermined period of time, and red after a final predetermined period of time).

Parents are advised to remove the contents of a bottle after 60 minutes because it is no longer fresh. Therefore, the ring 16 may be used as a timer to determine the freshness of the baby formula or breast milk in the bottle 10. This helps to prevent feeding the infant formula or milk from a previous feeding. More predetermined periods of time, and associated colors, can be added to the process as second, third, fourth, or more predetermined periods of time.

The ring 16 employs an endothermic chemical reaction which is well known to the art. The proportions of the chemicals used in the reaction are precisely formulated, such that the two color changes preferably occur exactly at 30-minute intervals. Each nipple 15 provides a transparent cap 17 which may snap on, or be affixed by screw threads. Once the nipple 15 is affixed to the bottle and aligned properly, feeding may begin.

To use the first exemplary embodiment, the user may pour prepared baby formula or breast milk into one of the bottles (11 and/or 12), enclosing the bottle (11 and/or 12) with a nipple 15 and ring 16. The user then begins feeding an infant with the bottle (11 or 12), and the ring 16 immediately changes color to green (or glows green in the glow in the dark embodiment) when the ring 16 is activated by a heat source. The user may observe the color changes of the ring 16 from green to yellow (or glowing yellow in the glow in the dark embodiment), and yellow to red (or glowing red in the glow in the dark embodiment). The user may use the color changes as a timer to determine when to take the bottle (11 and/or 12) away from the infant. The user may keep the bottles (11 and 12) affixed to one another, such that when the infant is finished feeding from one bottle 11, the serving pair 10 may be inverted and feeding may continue with the other bottle 12.

The bottles (11 and/or 12) and the caps 17 are preferably manufactured from a rigid, durable material which is transparent, shatterproof, and dishwasher safe, such as plastic or malacrylate. The nipples 15 are preferably manufactured from a flexible, durable material such as silicone. The rings 16 are preferably manufactured from a flexible, durable material such as silicone or plastic, containing materials which change color when subjected to heat, such as bromophenol.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A baby bottle serving pair with freshness indicator, comprising:
a. two baby bottles consisting of an upper baby bottle and a lower baby bottle each having a bottom surface;
b. said bottom surface of the upper baby bottle providing female screw threads;
c. said bottom surface of the lower baby bottle providing male screw threads;
d. said upper baby bottle and said lower baby bottle being configured to attach to each other via said respective screw threads;
e. said two baby bottles each providing a nipple opposite each respective bottom surface;
f. said two baby bottles each providing a heat sensitive ring;
g. said heat sensitive ring being configured to activate when exposed to a heat source; and
h. said heat sensitive ring being configured to change color after at least one predetermined period of time due to precisely formulated chemical reactions.

2. The baby bottle serving pair with freshness indicator of claim 1, wherein the heat sensitive ring is configured to turn green upon being activated.

3. The baby bottle serving pair with freshness indicator of claim 2, wherein the heat sensitive ring is configured to turn yellow after a first predetermined period of time and the heat sensitive ring is configured to turn red after a final predetermined period of time.

4. The baby bottle serving pair with freshness indicator of claim 3, wherein the first predetermined period of time is equal to thirty minutes after activation and the second predetermined period of time is sixty minutes after activation.

5. The baby bottle serving pair of claim 1, wherein said heat sensitive ring additionally requires airflow through the nipple to become activated.

6. The baby bottle serving pair with freshness indicator of claim 5, wherein the heat sensitive ring is configured to turn green upon being activated.

7. The baby bottle serving pair with freshness indicator of claim 6, wherein the heat sensitive ring is configured to turn yellow after a first predetermined period of time and the heat sensitive ring is configured to turn red after a final predetermined period of time.

8. The baby bottle serving pair with freshness indicator of claim 7, wherein the first predetermined period of time is equal to thirty minutes after activation and the second predetermined period of time is sixty minutes after activation.

9. The baby bottle serving pair with freshness indicator of claim 1, wherein each nipple provides a transparent cap which may snap on, or be affixed by screw threads.

10. A method of using a baby bottle serving pair with freshness indicator comprising:
a. two baby bottles consisting of an upper baby bottle and a lower baby bottle each having a bottom surface;
b. said bottom surface of the upper baby bottle providing female screw threads;
c. said bottom surface of the lower baby bottle providing male screw threads;
d. said upper baby bottle and said lower baby bottle being configured to attach to each other via said respective screw threads;
e. said two baby bottles each providing a nipple opposite each respective bottom surface;
f. said two baby bottles each providing a heat sensitive ring;
g. said heat sensitive ring being configured to activate when exposed to a heat source;
h. said heat sensitive ring being configured to change color after predetermined periods of time due to precisely formulated chemical reactions;
i. wherein the heat sensitive ring is configured to turn green upon being activated;
j. wherein the heat sensitive ring is configured to turn red after a final predetermined period of time.
and a method comprising:
k. filling at least one of the two baby bottles with a fluid;
l. affixing the nipple to the baby bottle or baby bottles filled with fluid;
m. feeding an infant with one of the baby bottles filled with liquid;
n. said heat sensitive ring turning green when activated by a heat source;
o. said heat sensitive ring turning red after the final predetermined period of time;
p. feeding of the infant is stopped when the heat sensitive ring turns red.

11. The method of using a baby bottle serving pair with freshness indicator of claim 10, further comprising: said heat sensitive ring being configured to turn yellow after a first predetermined period of time; and the method step of the heat sensitive ring turning yellow after a first predetermined period of time.

12. The method of using a baby bottle serving pair with freshness indicator of claim 10, wherein both baby bottles are filled with fluid; when feeding of the infant with the upper bottle is completed the infant is fed with the lower baby bottle.

13. The method of using a baby bottle serving pair with freshness indicator of claim 10, wherein said heat sensitive ring additionally requires airflow through the nipple to become activated; and the method step of the heat sensitive ring only turning green when air flows through the nipple.

14. The method of using a baby bottle serving pair with freshness indicator of claim 13, further comprising: said heat sensitive ring being configured to turn yellow after a first predetermined period of time; and the method step of the heat sensitive ring turning yellow after a first predetermined period of time.

15. The method of using a baby bottle serving pair with freshness indicator of claim 13, wherein both baby bottles are filled with fluid; when feeding of the infant with the upper bottle is completed the infant is fed with the lower baby bottle.

16. The baby bottle serving pair with freshness indicator of claim 1, wherein said heat sensitive ring is luminescent such that the heat sensitive ring glows in the dark in the same color as the ring.

17. The baby bottle serving pair with freshness indicator of claim 3, wherein said heat sensitive ring is luminescent such that the heat sensitive ring glows in the dark in the same color as the ring.

18. The baby bottle serving pair with freshness indicator of claim 7, wherein said heat sensitive ring is luminescent such that the heat sensitive ring glows in the dark in the same color as the ring.

19. The method of using a baby bottle serving pair with freshness indicator of claim 10, wherein said heat sensitive ring is luminescent such that the heat sensitive ring glows in the dark in the same color as the ring.

20. The method of using a baby bottle serving pair with freshness indicator of claim 11, wherein said heat sensitive ring is luminescent such that the heat sensitive ring glows in the dark in the same color as the ring.
